(19) United States
(12) Patent Application Publication
(10) Pub. No.: US 2024/0075385 A1
(43) Pub. Date: Mar. 7, 2024

(54) INTERACTIVE DYNAMIC NARRATIVE PRODUCTION AND PLAYBACK

(71) Applicant: Haiba LLC, Cupertino, CA (US)

(72) Inventors: Rachid El GUERRAB, Cupertino, CA (US); James RITTS, Los Angeles, CA (US)

(21) Appl. No.: 18/241,627

(22) Filed: Sep. 1, 2023

Related U.S. Application Data
(60) Provisional application No. 63/403,220, filed on Sep. 1, 2022.
(60) Provisional application No. 63/535,995, filed on Aug. 31, 2023.

(51) Int. Cl. A63F 13/47; A63F 13/44

(52) U.S. Cl. CPC A63F 13/47; A63F 13/44

(57) ABSTRACT

An interactive dynamic narrative production system is provided that includes an editor tool set that facilitates collaboration to generate an interactive story file comprising a rich variety of media arranged together using story flow, branching, interaction, and timing elements. The system also includes a multiplatform player to allow for playback of the interactive story file on a variety of different platforms.

### RELATED APPLICATION

The present application claims priority to U.S. provisional patent application No. 63/403,220 filed 1 Sep. 2022 and claims priority to U.S. provisional patent application No. 63/535,995 filed 31 Aug. 2023, each of which is incorporated herein by reference in its entirety.

### BACKGROUND

### Field of the Invention

The present disclosure generally relates to multi-media production and more particularly relates to an integrated collaborative toolset to conceptualize, develop, and publish multi-platform interactive real-time narratives.

### Related Art

Content production has made significant progress over the last few decades. This progress has seen major advances in a variety of different areas including virtual reality, augmented reality, voice recognition, body tracking, sensor data capture and input, specialized hardware and software, computer generated imagery, animation, programmable remotes, and gesture detection, just to name a few. Unfortunately, this progress has been substantially fragmented such that integrating various types of content requires highly specialized technical expertise and costly and time-consuming research and development. Therefore, what is needed is a system and method that overcomes these significant problems found in the conventional systems as described above.

### SUMMARY

The present disclosure addresses the problems described above by providing a technical framework that includes a multi-media toolset that operates on a rich variety of media using an extended film language and common data infrastructure in combination with a multiplatform player to allow for seamless development and production.

In some aspects, the techniques described herein relate to a system including: a non-transitory computer readable medium configured to store media including image files, sound files, video files, text files, and an executable editor module; a processor communicatively coupled with the non-transitory computer readable medium and configured to execute the editor module to: identify a plurality of elements corresponding to a first interactive story, the plurality of elements including one or more of: one or more media elements, one or more timing elements, one or more branch elements, and one or more interaction elements; combine the plurality of elements into a story flow that directly or indirectly relates each of the plurality of elements to each of the other of the plurality of elements; and generate the first interactive story based on the plurality of elements and the story flow.

In some aspects, the techniques described herein relate to a system, wherein the one or more media elements includes one or more of text files, image files, video files, and sound files.

In some aspects, the techniques described herein relate to a system, wherein a timing element defines a duration of at least one of the plurality of elements corresponding to the first interactive story.

In some aspects, the techniques described herein relate to a system, wherein a branch element defines an ordered relationship between two or more of the plurality of elements corresponding to the first interactive story.

In some aspects, the techniques described herein relate to a system, wherein a first branch element defines at least two optional second elements that sequentially follow a first element in the first interactive story.

In some aspects, the techniques described herein relate to a system, wherein an interaction element defines a user input or an absence of a user input corresponding to the first interactive story.

In some aspects, the techniques described herein relate to a system, further including: combine a first portion of the plurality of elements into a first moment; combine a second portion of the plurality of elements into a second moment; and defining an ordered sequence between the first moment and the second moment in the first interactive story.

In some aspects, the techniques described herein relate to a computer implemented method, where one or more processors are programmed to perform steps including: receive a plurality of elements including one or more media elements, one or more timing elements, one or more branch elements, one or more interaction elements, and one or more story flow relationships; directly or indirectly relate each of the plurality of elements to each of the other of the plurality of elements corresponding to the one or more story flow relationships; and generate an interactive story file based on the directly or indirectly related plurality of elements and the story flow relationships.

In some aspects, the techniques described herein relate to a method, wherein the one or more media elements includes one or more of text files, image files, video files, and sound files.

In some aspects, the techniques described herein relate to a method, wherein a timing element defines a duration of at least one of the plurality of elements corresponding to the first interactive story.

In some aspects, the techniques described herein relate to a method, wherein a branch element defines an ordered relationship between two or more of the plurality of elements corresponding to the first interactive story.

In some aspects, the techniques described herein relate to a method, wherein a first branch element defines at least two optional second elements that sequentially follow a first element in the first interactive story.

In some aspects, the techniques described herein relate to a method, wherein an interaction element defines a user input or an absence of a user input corresponding to the first interactive story.

In some aspects, the techniques described herein relate to a method, wherein the one or more processors are further programmed to perform steps including: combine a first portion of the plurality of elements into a first moment; combine a second portion of the plurality of elements into a second moment; defining an ordered sequence between the first moment and the second moment corresponding to the one or more story flow relationships; wherein, generating the interactive story file includes generating the interactive story file based on the plurality of elements, the first moment, the second moment, and the story flow relationships.

In some aspects, the techniques described herein relate to a non-transitory computer readable medium having stored thereon one or more sequences of instructions for causing one or more processors to perform steps including: receive a plurality of elements including one or more media elements, one or more timing elements, one or more branch elements, one or more interaction elements, and one or more story flow relationships; combine a first portion of the plurality of elements into a first moment; combine a second portion of the plurality of elements into a second moment; defining an ordered sequence between the first moment and the second moment corresponding to the one or more story flow relationships; and generate an interactive story file based on the plurality of elements, the first moment, the second moment, and the story flow relationships.

In some aspects, the techniques described herein relate to a non-transitory computer readable medium, wherein the one or more sequences of instructions cause the one or more processors to further perform steps including: directly or indirectly relate each of the plurality of elements to each of the other of the plurality of elements corresponding to the one or more story flow relationships.

Other features and advantages of the present invention will become more readily apparent to those of ordinary skill in the art after reviewing the following detailed description and accompanying drawings.

### BRIEF DESCRIPTION OF THE DRAWINGS

The structure and operation of the present invention will be understood from a review of the following detailed description and the accompanying drawings in which like reference numerals refer to like parts and in which:

FIG. 1 illustrates an example infrastructure, in which one or more of the processes described herein, may be implemented, according to an embodiment;

FIG. 2 illustrates an example processing system, by which one or more of the processes described herein, may be executed, according to an embodiment; and

FIG. 3 is a flow diagram illustrating an example process for generating an interactive dynamic narrative according to an embodiment of the invention.

### DETAILED DESCRIPTION

Disclosed herein are systems, methods, and non-transitory computer-readable media for the creation of interactive content on various platforms for delivery to various platforms. For example, one method disclosed herein allows for an interactive story file to be generated by an editor by combining a script and media elements with story flow, timing, interaction, and how individual media elements are to be used. The interactive story file is executed by a playback system adapted to the capabilities of the playback platform/device.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

Example System Overview

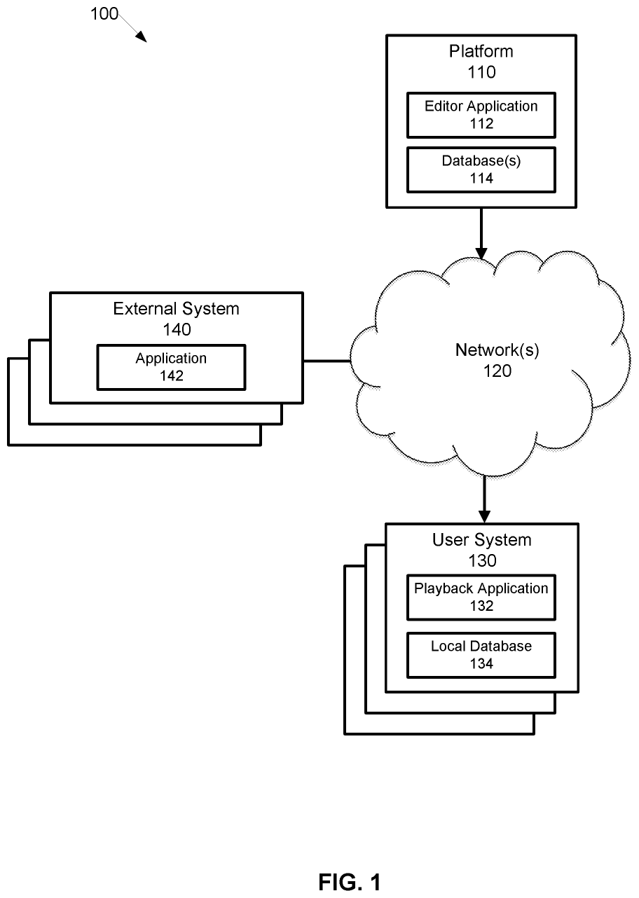

FIG. 1 illustrates an example infrastructure in which one or more of the disclosed processes may be implemented, according to an embodiment. The infrastructure may comprise a platform 110 (e.g., one or more servers) which hosts and/or executes one or more of the various functions, processes, methods, and/or software modules described herein. Platform 110 may comprise dedicated servers, or may instead comprise cloud instances, which utilize shared resources of one or more servers. These servers or cloud instances may be collocated and/or geographically distributed. Platform 110 may also comprise or be communicatively connected to an editor application 112 and/or one or more databases 114 for storing scripts and media (e.g., images, sounds, videos, etc.) and interactive story files that are generated by the editor application 112 based on scripts and media. In addition, platform 110 may be communicatively connected to one or more user systems 130 via one or more networks 120. Platform 110 may also be communicatively connected to one or more external systems 140 (e.g., other platforms, websites, etc.) via one or more networks 120.

External systems 140 may be sources of additional media or scripts or toolsets and they may also be remote access systems that facilitate authors and editors and creators who contribute to the creation of portions of the script and media that are used by the platform 110 to generate an interactive story file. For example, external systems 140 may include an application 142 that facilitates communication with the editor application 112 on the platform 110 to allow a collaborator at the external system 140 to participate in creating content on the platform 110. In such an embodiment, an application 142 executing on one or more external system(s) 140 may interact with an editor application 112 executing on platform 110 to execute one or more or a portion of one or more of the various functions, processes, methods, and/or software modules described herein. Application 142 may be “thin,” in which case processing is primarily carried out server-side by editor application 112 on platform 110. A basic example of a thin application 142 is a browser application, which simply requests, receives, and renders webpages at user system(s) 130, while editor application 112 on platform 110 is responsible for generating the webpages and managing database functions. Alternatively, the application 142 may be “thick,” in which case processing is primarily carried out client-side by external system(s) 140. It should be understood that application 142 may perform an amount of processing, relative to editor application 112 on platform 110, at any point along this spectrum between “thin” and “thick,” depending on the design goals of the particular implementation. In any case, the application described herein, which may wholly reside on either platform 110 (e.g., in which case editor application 112 performs all processing) or external system(s) 140 (e.g., in which case application 142 performs all processing) or be distributed between platform 110 and external system(s) 140 (e.g., in which case editor application 112 and application 142 both perform processing), can comprise one or more executable software modules that implement one or more of the processes, methods, or functions of the application described herein.

Network(s) 120 may comprise the Internet, and platform 110 may communicate with user system(s) 130 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems through a single set of network(s) 120, it should be understood that platform 110 may be connected to the various systems via different sets of one or more networks. For example, platform 110 may be connected to a subset of user systems 130 and/or external systems 140 via the Internet, but may be connected to one or more other user systems 130 and/or external systems 140 via an intranet. Furthermore, while only a few user systems 130 and external systems 140, one editor application 112, and one set of database(s) 114 are illustrated, it should be understood that the infrastructure may comprise any number of user systems, external systems, server applications, and databases.

User system(s) 130 may comprise any type or types of computing devices capable of wired and/or wireless communication, including without limitation, desktop computers, laptop computers, tablet computers, smart phones or other mobile phones, servers, game consoles, head mounted displays, televisions, set-top boxes, movie theaters, electronic kiosks, multi-media centers, interactive gaming centers, and/or the like. User system(s) 130 may include a local database 134 for storing data such as interactive story files. User system(s) 130 may also include one or more playback applications 132 that are configured to execute an interactive story file to provide the interactive production to one or more users. In on embodiment, the playback application 132 includes a narrative engine, an interaction engine, and a media engine that are each configured to render portions of the interactive story file when providing the interactive production to one or more users.

Platform 110 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 110 transmits or serves one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 120, which may include the Internet, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database(s) 114) that are locally and/or remotely accessible to platform 110. Platform 110 may also respond to other requests from user system(s) 130.

Platform 110 may further comprise, be communicatively coupled with, or otherwise have access to one or more database(s) 114. For example, platform 110 may comprise one or more database servers which manage one or more databases 114. A user system 130 or editor application 112 executing on platform 110 may submit data (e.g., user data, form data, etc.) to be stored in database(s) 114, and/or request access to data stored in database(s) 114. Any suitable database may be utilized, including without limitation MySQL™, Oracle™, IBM™, Microsoft SQL™, Access™, PostgreSQL™, and the like, including cloud-based databases and proprietary databases. Data may be sent to platform 110, for instance, using the well-known POST request supported by HTTP, via FTP, and/or the like. This data, as well as other requests, may be handled, for example, by server-side web technology, such as a servlet or other software module (e.g., comprised in editor application 112), executed by platform 110.

In embodiments in which a web service is provided, platform 110 may receive requests from external system(s) 140, and provide responses in eXtensible Markup Language (XML), JavaScript Object Notation (JSON), and/or any other suitable or desired format. In such embodiments, platform 110 may provide an application programming interface (API) which defines the manner in which user system(s) 130 and/or external system(s) 140 may interact with the web service. Thus, user system(s) 130 and/or external system(s) 140 (which may themselves be servers), can define their own user interfaces, and rely on the web service to implement or otherwise provide the backend processes, methods, functionality, storage, and/or the like, described herein.

For example, in such an embodiment, a client playback application 132 executing on one or more user system(s) 130 may interact with an editor application 112 executing on platform 110 to execute one or more or a portion of one or more of the various functions, processes, methods, and/or software modules described herein. Client playback application 132 may be “thin,” in which case processing is primarily carried out server-side by editor application 112 on platform 110. A basic example of a thin client playback application 132 is a browser application, which simply requests, receives, and renders webpages at user system(s) 130, while editor application 112 on platform 110 is responsible for generating the webpages and managing database functions. Alternatively, the client application may be “thick,” in which case processing is primarily carried out client-side by user system(s) 130. It should be understood that client playback application 132 may perform an amount of processing, relative to editor application 112 on platform 110, at any point along this spectrum between “thin” and “thick,” depending on the design goals of the particular implementation. In any case, the application described herein, which may wholly reside on either platform 110 (e.g., in which case editor application 112 performs all processing) or user system(s) 130 (e.g., in which case client playback application 132 performs all processing) or be distributed between platform 110 and user system(s) 130 (e.g., in which case editor application 112 and client playback application 132 both perform processing), can comprise one or more executable software modules that implement one or more of the processes, methods, or functions of the application described herein.

Example System Operation

The operation of the system is explained in detail in the attached appendix. In general, collaborators work cooperatively to create and update the script and media files that are part of an interactive story file generated by the editor application 112 that runs on the platform 110. The collaborators may access the platform 110 directly or via a local or remote workstation such as external system 140. The collaborators use the editor application 112 to weave together script and media elements into a story flow that may include various branches and interactions and may include instructions for how an individual media element is to be used in the interactive story.

After the collaborators have finished creation of the interactive story, the editor application 112 generates the interactive story file and this file can be delivered via network 120 to one or more user playback stations 130 where the interactive story file is executed by a playback application 132 to deliver the interactive production to the user.

Example Processing Device

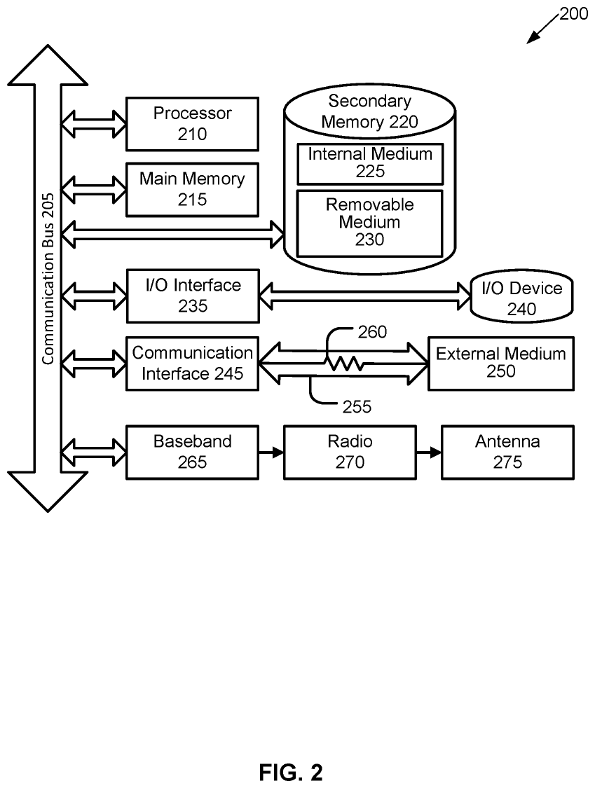

FIG. 2 is a block diagram illustrating an example wired or wireless system 200 that may be used in connection with various embodiments described herein. For example, system 200 may be used as or in conjunction with one or more of the functions, processes, or methods (e.g., to store and/or execute the application or one or more software modules of the application) described herein, and may represent components of platform 110, user system(s) 130, external system(s) 140, and/or other processing devices described herein. System 200 can be a server or any conventional personal computer, or any other processor-enabled device that is capable of wired or wireless data communication. Other computer systems and/or architectures may be also used, as will be clear to those skilled in the art.

System 200 preferably includes one or more processors, such as processor 210. Additional processors may be provided, such as an auxiliary processor to manage input/output, an auxiliary processor to perform floating-point mathematical operations, a special-purpose microprocessor having an architecture suitable for fast execution of signal-processing algorithms (e.g., digital-signal processor), a slave processor subordinate to the main processing system (e.g., back-end processor), an additional microprocessor or controller for dual or multiple processor systems, and/or a coprocessor. Such auxiliary processors may be discrete processors or may be integrated with processor 210. Examples of processors which may be used with system 200 include, without limitation, the Pentium® processor, Core i7® processor, and Xeon® processor, all of which are available from Intel Corporation of Santa Clara, California.

Processor 210 is preferably connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 preferably includes a main memory 215 and may also include a secondary memory 220. Main memory 215 provides storage of instructions and data for programs executing on processor 210, such as one or more of the functions and/or modules discussed herein. It should be understood that programs stored in the memory and executed by processor 210 may be written and/or compiled according to any suitable language, including without limitation C/C++, Java, JavaScript, Perl, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 220 may optionally include an internal medium 225 and/or a removable medium 230. Removable medium 230 is read from and/or written to in any well-known manner. Removable storage medium 230 may be, for example, a magnetic tape drive, a compact disc (CD) drive, a digital versatile disc (DVD) drive, other optical drive, a flash memory drive, and/or the like.

Secondary memory 220 is a non-transitory computer-readable medium having computer-executable code (e.g., disclosed software modules) and/or other data stored thereon. The computer software or data stored on secondary memory 220 is read into main memory 215 for execution by processor 210.

In alternative embodiments, secondary memory 220 may include other similar means for allowing computer programs or other data or instructions to be loaded into system 200. Such means may include, for example, a communication interface 245, which allows software and data to be transferred from external storage medium 250 to system 200. Examples of external storage medium 250 may include an external hard disk drive, an external optical drive, an external magneto-optical drive, and/or the like. Other examples of secondary memory 220 may include semiconductor-based memory, such as programmable read-only memory (PROM), erasable programmable read-only memory (EPROM), electrically erasable read-only memory (EEPROM), and flash memory (block-oriented memory similar to EEPROM).

As mentioned above, system 200 may include a communication interface 245. Communication interface 245 allows software and data to be transferred between system 200 and external devices (e.g. printers), networks, or other information sources. For example, computer software or executable code may be transferred to system 200 from a network server (e.g., platform 110) via communication interface 245. Examples of communication interface 245 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 245 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 245 are generally in the form of electrical communication signals 260. These signals 260 may be provided to communication interface 245 via a communication channel 255. In an embodiment, communication channel 255 may be a wired or wireless network (e.g., network(s) 120), or any variety of other communication links. Communication channel 255 carries signals 260 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (e.g., computer programs, such as the disclosed application, or software modules) is stored in main memory 215 and/or secondary memory 220. Computer programs can also be received via communication interface 245 and stored in main memory 215 and/or secondary memory 220. Such computer programs, when executed, enable system 200 to perform the various functions of the disclosed embodiments as described elsewhere herein.

In this description, the term “computer-readable medium” is used to refer to any non-transitory computer-readable storage media used to provide computer-executable code and/or other data to or within system 200. Examples of such media include main memory 215, secondary memory 220 (including internal memory 225, removable medium 230, and external storage medium 250), and any peripheral device communicatively coupled with communication interface 245 (including a network information server or other network device). These non-transitory computer-readable media are means for providing executable code, programming instructions, software, and/or other data to system 200.

In an embodiment that is implemented using software, the software may be stored on a computer-readable medium and loaded into system 200 by way of removable medium 230, I/O interface 235, or communication interface 245. In such an embodiment, the software is loaded into system 200 in the form of electrical communication signals 260. The software, when executed by processor 210, preferably causes processor 210 to perform one or more of the processes and functions described elsewhere herein.

In an embodiment, I/O interface 235 provides an interface between one or more components of system 200 and one or more input and/or output devices 240. Example input devices include, without limitation, sensors, keyboards, touch screens or other touch-sensitive devices, biometric sensing devices, computer mice, trackballs, pen-based pointing devices, and/or the like. Examples of output devices include, without limitation, other processing devices, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), head mounted displays (HMDs), and/or the like. In some cases, an input and output device 240 may be combined, such as in the case of a touch panel display (e.g., in a smartphone, tablet, or other mobile device).

In an embodiment, the I/O device 240 may be any type of external or integrated display and may include one or more discrete displays that in aggregate form the I/O device 240. The I/O device 240 may be capable of 2D or 3D presentation of visual information to a user of the system 200. In one embodiment, the I/O device 240 may be a virtual reality or augmented reality device in the form of HMD by the user so the user may visualize the presentation of information in 3D.

System 200 may also include optional wireless communication components that facilitate wireless communication over a voice network and/or a data network (e.g., in the case of user system 130). The wireless communication components comprise an antenna system 275, a radio system 270, and a baseband system 265. In system 200, radio frequency (RF) signals are transmitted and received over the air by antenna system 275 under the management of radio system 270.

In an embodiment, antenna system 275 may comprise one or more antennae and one or more multiplexors (not shown) that perform a switching function to provide antenna system 275 with transmit and receive signal paths. In the receive path, received RF signals can be coupled from a multiplexor to a low noise amplifier (not shown) that amplifies the received RF signal and sends the amplified signal to radio system 270.

In an alternative embodiment, radio system 270 may comprise one or more radios that are configured to communicate over various frequencies. In an embodiment, radio system 270 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 270 to baseband system 265.

If the received signal contains audio information, then baseband system 265 decodes the signal and converts it to an analog signal. Then the signal is amplified and sent to a speaker. Baseband system 265 also receives analog audio signals from a microphone. These analog audio signals are converted to digital signals and encoded by baseband system 265. Baseband system 265 also encodes the digital signals for transmission and generates a baseband transmit audio signal that is routed to the modulator portion of radio system 270. The modulator mixes the baseband transmit audio signal with an RF carrier signal, generating an RF transmit signal that is routed to antenna system 275 and may pass through a power amplifier (not shown). The power amplifier amplifies the RF transmit signal and routes it to antenna system 275, where the signal is switched to the antenna port for transmission.

Baseband system 265 is also communicatively coupled with processor 210, which may be a central processing unit (CPU). Processor 210 has access to data storage areas 215 and 220. Processor 210 is preferably configured to execute instructions (i.e., computer programs, such as the disclosed application, or software modules) that can be stored in main memory 215 or secondary memory 220. Computer programs can also be received from baseband processor 260 and stored in main memory 210 or in secondary memory 220, or executed upon receipt. Such computer programs, when executed, enable system 200 to perform the various functions of the disclosed embodiments.

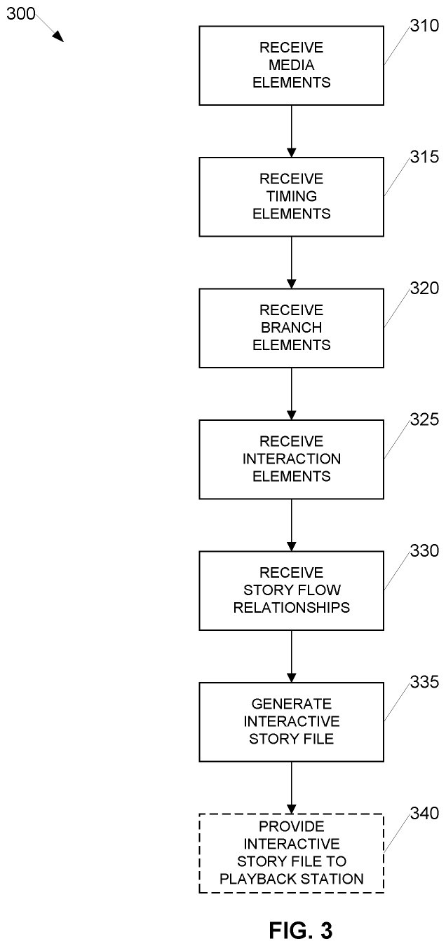

FIG. 3 is a flow diagram illustrating an example process for generating an interactive dynamic narrative according to an embodiment of the invention. In one aspect, the process of FIG. 3 may be carried out by the system described with respect to FIG. 1 in combination with one or more processing devices described with respect to FIG. 2. It should be noted that the process of FIG. 3 may be carried out in an order other than the illustrated order.

Initially, at 310, the system receives one or more media elements. A media element may be a text file, a sound file, an image file, a video file, or some other type of media file. Next, at 315, the system receives on or more timing elements. A time element may define a duration for a media element or a duration of a pause in the story flow, or a duration of overlapping media elements such as sounds and text and images. Next, at 320, the system receives one or more branch elements. A branch element may define the next sequential element in the story flow. A branch element may also define two or more optional next sequential elements in the story flow or a path that loops back to a prior element in the story flow. In one aspect, branch elements define where the story flows to next.

Next, at 325, the system receives one or more interaction element. An interaction element may define a user input or an absence of a user input. For example, in an immersive virtual reality interactive story, an interaction element may be the user changing position (e.g., sitting down, standing up, or turning around), or the user touching an object (e.g., pushing a button or pulling a lever). Many varieties of interaction elements may be defined and they may be active (such as a user input or a user action) or they may be passive (such as the user remaining motionless).

Next, at 330, the system receives one or more story flow relationships. A story flow relationship may define when the interactive story moves from a first moment to a second moment or a third moment. In one aspect, a moment is a collection of elements that, for example, collectively define a scene in the interactive story. In one aspect, the story flow relationships between elements and/or the story flow relationships between moments and/or the story flow relationships between elements and moments define when the story flows to the next element or moment. The story flow relationships may also define which branch to follow from the current element/moment to the next element/moment. For example, the story flow relationship may define that the story flows from the current moment to one of three next moments based on an interaction element such as a user selection. In one aspect, the story flow relationships relate each of the various elements of the interactive story directly or indirectly to each other.

Next, at 335, the system generates the interactive story file based on the media elements, the timing elements, the branch elements, the interaction elements, and the story flow relationships. Accordingly, the interactive story file comprises a plurality of elements that are all directly or indirectly linked together by way of the branch elements and the story flow relationships, with the media elements providing content and the timing elements defining the pacing of the story, and the interaction elements allowing the story to flow in accordance with active or passive user feedback.

Next, at 340, the system optionally provides the interactive story file to a playback station where the interactive story file can be played. In one aspect, the interactive story file may be provided to a playback station via a wired or wireless data communication network such as the Internet.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

What is claimed is:

1. A system comprising:
a non-transitory computer readable medium configured to store media comprising image files, sound files, video files, text files, and an executable editor module;
at least one processor communicatively coupled with the non-transitory computer readable medium and configured to:
identify a plurality of elements corresponding to a first interactive story, the plurality of elements comprising one or more of:
one or more media elements,
one or more timing elements,
one or more branch elements, and
one or more interaction elements;
combine the plurality of elements into a story flow that directly or indirectly relates each of the plurality of elements to each of the other of the plurality of elements; and
generate the first interactive story based on the plurality of elements and the story flow.

2. The system of claim 1, wherein the one or more media elements comprises one or more of text files, image files, video files, and sound files.

3. The system of claim 1, wherein a timing element defines a duration of at least one of the plurality of elements corresponding to the first interactive story.

4. The system of claim 1, wherein a branch element defines an ordered relationship between two or more of the plurality of elements corresponding to the first interactive story.

5. The system of claim 4, wherein a first branch element defines at least two optional second elements that sequentially follow a first element in the first interactive story.

6. The system of claim 1, wherein an interaction element defines a user input or an absence of a user input corresponding to the first interactive story.

7. The system of claim 1, wherein the at least one processor is further configured to:
combine a first portion of the plurality of elements into a first moment;
combine a second portion of the plurality of elements into a second moment; and
defining an ordered sequence between the first moment and the second moment in the first interactive story.

8. The system of claim 1, wherein the at least one processor is further configured to:
provide the interactive story file to a playback station via a data communication network.

9. A computer implemented method, where one or more processors are programmed to perform steps comprising:
receive a plurality of elements comprising one or more media elements, one or more timing elements, one or more branch elements, one or more interaction elements, and one or more story flow relationships;
directly or indirectly relate each of the plurality of elements to each of the other of the plurality of elements corresponding to the one or more story flow relationships; and
generate an interactive story file based on the directly or indirectly related plurality of elements and the story flow relationships.

10. The method of claim 9, wherein the one or more media elements comprises one or more of text files, image files, video files, and sound files.

11. The method of claim 9, wherein a timing element defines a duration of at least one of the plurality of elements corresponding to the first interactive story.

12. The method of claim 9, wherein a branch element defines an ordered relationship between two or more of the plurality of elements corresponding to the first interactive story.

13. The method of claim 12, wherein a first branch element defines at least two optional second elements that sequentially follow a first element in the first interactive story.

14. The method of claim 9, wherein an interaction element defines a user input or an absence of a user input corresponding to the first interactive story.

15. The method of claim 9, wherein the one or more processors are further programmed to perform steps comprising:
combine a first portion of the plurality of elements into a first moment;
combine a second portion of the plurality of elements into a second moment;
defining an ordered sequence between the first moment and the second moment corresponding to the one or more story flow relationships;
wherein, generating the interactive story file comprises generating the interactive story file based on the plurality of elements, the first moment, the second moment, and the story flow relationships.

16. The method of claim 9, wherein the one or more processors are further programmed to perform steps comprising:
provide the interactive story file to a playback station via a data communication network.

17. A non-transitory computer readable medium having stored thereon one or more sequences of instructions for causing one or more processors to perform steps comprising:
receive a plurality of elements comprising one or more media elements, one or more timing elements, one or more branch elements, one or more interaction elements, and one or more story flow relationships;
combine a first portion of the plurality of elements into a first moment;
combine a second portion of the plurality of elements into a second moment;
defining an ordered sequence between the first moment and the second moment corresponding to the one or more story flow relationships; and
generate an interactive story file based on the plurality of elements, the first moment, the second moment, and the story flow relationships.

18. The non-transitory computer readable medium of claim 17, wherein the one or more sequences of instructions cause the one or more processors to further perform steps comprising:
directly or indirectly relate each of the plurality of elements to each of the other of the plurality of elements corresponding to the one or more story flow relationships.

19. The non-transitory computer readable medium of claim 17, wherein the one or more sequences of instructions cause the one or more processors to further perform steps comprising:
provide the interactive story file to a playback station via a data communication network.
